(19) United States
(12) Patent Application Publication
(10) Pub. No.: US 2005/0048997 A1
(43) Pub. Date: Mar. 3, 2005

(54) Wireless connectivity module

(76) Inventors: Mike Grobler, Aliso Viejo, CA (US); Glen E. Roeters, Huntington Beach, CA (US); Rod Corder, Fountain Valley, CA (US); Mike Zachan, Irvine, CA (US)

Correspondence Address: Kit M. Stetina, Esq.;STETINA BRUNDA GARRED & BRUCKER, 75 Enterprise, Suite 250, Aliso Viejo, CA, 92656, US

(21) Appl. No.: 10/653,381

(22) Filed: Sep. 2, 2003

(51) Int. Cl. G06F 9/00

(52) U.S. Cl. 455/550.1

(57) ABSTRACT

A module is provided for imparting wireless functionality to a host device. Software running on an application processor of the module can facilitate data exchange between the host device and a wireless radio of the module by converting data between a host-oriented protocol and a wireless protocol, thereby providing the host device with network connectivity. A configuration of the module can be changed by various command-based methods. Alternatively, the configuration can be changed by software running on a remote device in communication with the module over a wireless link. Flash memory can also be provided for storing the module configuration. Authentication can also be implemented to secure against the execution of unauthorized commands issued to the module. The module can allow for browser-based or command-based data exchange between the remote device and the host device over the wireless link.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to wireless technology, and more particularly to the addition of wireless functionality to host devices.

In the course of bringing electronic products to market, original equipment manufacturers (OEMs) may wish to provide wireless functionality to devices that would otherwise require wired operation. For example, a manufacturer of probes, sensors, or other industrial data collection or control devices may desire to offer wireless versions of its products for portable, handheld use. Unfortunately, the implementation of wireless functionality can pose a significant challenge to such OEMs.

Typically, an OEM's expertise will be limited to technological fields directly relevant to its products. In the example above, the OEM may have significant experience in designing and implementing test equipment, but may not have the skills necessary to develop test equipment that utilizes wireless communication. Moreover, for such an OEM, it may be cost-prohibitive to hire the necessary talent and fund the development of a device-specific wireless solution.

Indeed, even if an OEM develops a device-specific wireless implementation, it is still important for such a device to comply with industry-standard wireless protocols in order to ensure compatibility with other wireless devices and wireless communication networks. Ad hoc designs are unlikely to offer such compatibility,

Given the complexity of modem wireless networks, it is also desirable to configure wireless devices to ensure compatibility with other equipment. Depending on the particular environment in which a wireless device is deployed, different configurations may be necessary. For an OEM, configuring such a wireless device may require reviewing and changing the wireless device software. The writing and re-writing of large amounts of software code each time the configuration changes can be a time consuming and inefficient way for OEMs, or users of their products, to update the configuration of a wireless device.

Accordingly, there exists a need for an efficient, cost-effective way to implement wireless functionality in OEM devices that are compatible with industry-standard wireless protocols. There further exists a need to configure such devices in an efficient manner. Various embodiments of the present invention are directed toward meeting these, as well as other needs.

### BRIEF SUMMARY OF THE INVENTION

The present invention, roughly described, is directed to a module for providing wireless functionality to a host device, and related methods for configuring the module and exchanging data with the host device.

In one embodiment, the module includes a wireless radio supporting a wireless protocol, and an antenna in communication with the radio capable of transmitting and receiving wireless signals over a wireless link. Software running on an application processor of the module facilitates data exchange between a host device and the radio by converting data between a host-oriented protocol (or other appropriate protocol) and a wireless protocol, thereby providing the host device with network connectivity. Flash memory can also be provided for storing a configuration of the module.

In various embodiments, the configuration of the module is comprised of a plurality of configuration parameters. In such embodiments, the module can be remotely configured by software running on a remote device, or by commands issued by the remote device. Alternatively, the module configuration can be changed by commands issued by a host device.

In other embodiments, the module can allow for data exchange between a remote device and a host device over a wireless link. After receiving an HTML page request from the remote device over the wireless link, the module can return an HTML page having code that is executable by the remote device. By executing the code, the remote device can issue a data request command to the module. In response, the module can pass at least a portion of the command to the host device, which can return requested data that is received by the module. The module can return the requested data to the remote device where it can be formatted and displayed on a browser.

Other data exchange methods are also provided which utilize commands issued by a host device to physical ports of the module, or by a remote device over a wireless link. Authentication can also be implemented on the module to secure against the execution of unauthorized commands issued by the host device or remote device. These and other embodiments of the present invention are discussed in further detail below.

### BRIEF DESCRIPTION OF THE DRAWINGS

FIG. 1 is a block diagram illustrating a system that facilitates wireless communication between a host device and a remote device in accordance with an embodiment of the present invention.

FIG. 2 is a block diagram illustrating various components of a wireless module in accordance with an embodiment of the present invention.

FIG. 3 is a block diagram illustrating the software architecture of a wireless module in accordance with an embodiment of the present invention.

FIG. 4 is a block diagram illustrating various software components of a wireless module, access point, and remote device in accordance with an embodiment of the present invention.

FIG. 5 is a block diagram providing a conceptual illustration of the contents of flash memory files of a wireless module in accordance with an embodiment of the present invention.

FIG. 6 is a flowchart describing a process for browser-based data communication initiated by a remote device in accordance with an embodiment of the present invention.

FIG. 7 is a flowchart describing a process for command-based data communication initiated by a host device or remote device in accordance with an embodiment of the present invention.

FIG. 8 is a flowchart describing an alternate process for command-based data communication initiated by a host device in accordance with an embodiment of the present invention.

FIG. 9 is a flowchart describing an alternate process for command-based data communication initiated by a remote device in accordance with an embodiment of the present invention.

FIG. 10 is a flowchart describing a process for configuring a module using a configuration utility in accordance with an embodiment of the present invention.

FIG. 11 is a flowchart describing a process for authenticating commands issued to a module in accordance with an embodiment of the present invention.

### DETAILED DESCRIPTION OF THE INVENTION

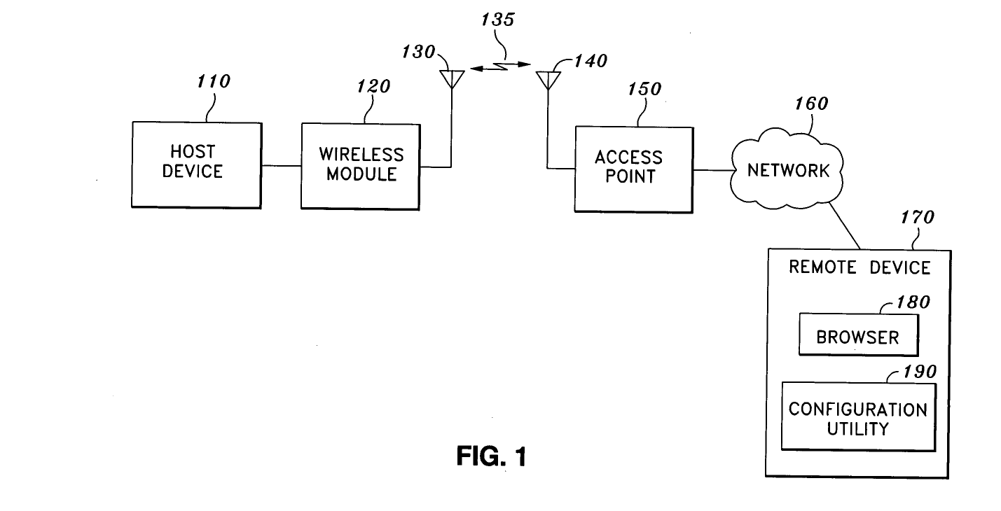

FIG. 1 is a block diagram of a system that facilitates wireless communication between a host device and a remote device in accordance with an embodiment of the present invention. The system of FIG. 1 provides a host device 110 and wireless module 120 in communication with access point 150 over wireless link 135. Access point 150 is in communication with remote device 170 over network 160. As illustrated by the connections of FIG. 1, module 120 allows for communication between host 110 and remote device 170 over wireless link 135, access point 150, and network 160.

In various embodiments of the present invention, module 120 can provide data from host 110 to remote device 170, thereby permitting host 110 to communicate wirelessly over link 135. In other embodiments, module 120 can be configured by host 110 or remotely over link 135 by remote device 170.

Host 110 can be any hardware device to which it may be desirable to add wireless functionality. For example, host 110 can be a data acquisition or control device for use with industrial, scientific, medical, and automotive (“ISMA”) applications. Other possible applications include, but are not limited to: instrumentation, factory automation, health care, building control, remote sensors, point of sale systems, and security systems. Typically, host 110 will include a processor which is capable of communicating with module 120.

Module 120 allows host 110 to communicate wirelessly with other components of the system of FIG. 1. In various embodiments, module 120 can be incorporated into host 110 by an OEM, allowing the OEM to provide host 110 with wireless functionality, without having to develop such technology anew. Module 120 can be implemented as a small, fully integrated wireless device that can be connected to, or embedded in, host 110. By reducing the need for OEMs to deal with the complexities of RF system design, development, and testing, module 120 allows OEMs to quickly incorporate wireless connectivity into host 110. For example, module 120 can be implemented as a “drop-in” module embedded in host 110 as part of a product offering by an OEM. It is contemplated that various embodiments of module 120 can provide ISMA system OEMs with a family of wireless connectivity products that utilize industry standard, cost effective wireless networking technologies to create reliable, industrial grade data acquisition and control systems.

Module 120 can communicate with host 110 by way of physical ports on the module 120, as further described herein. Various embodiments of module 120 can communicate with access point 150 using different wireless protocols, including IEEE 802.11 wireless standards (such as 802.11a, b, g), Bluetooth® wireless technology, a WiFi compatible protocol, a protocol complying with a ZigBee™ wireless technology, a protocol complying with an UWB (ultra wide band) wireless technology, or others known in the art. For example, when deployed for use with 802.11b networks, module 120 can provide a complete 802.11b network interface, thereby allowing host 110 to communicate wirelessly with a WiFi compatible 802.11b network. It is further contemplated that module 120 can have an IP address that is assigned a default value and/or dynamically allocated by using the dynamic host control protocol (DHCP).

There are several alternative ways in which module 120 can communicate with the various components of FIG. 1. For example, in various embodiments, module 120 can support: (a) communication with host 110 over a serial interface; (b) communication with remote device 170 through a web server of module 120; (c) communication with remote device 170 through a Telnet server of module 120; and/or (d) communication over a TCP connection initiated by module 120. In various embodiments, each of the communication means (a), (b), and (c) above (collectively referred to as “CLI communication interfaces” herein) can support the use of CLI commands, as further described herein.

Antennas 130 and 140 are capable of sending and receiving wireless communications between module 120 and access point 150 over wireless link 135 in accordance with the present invention. Access point 150 is a wireless device that serves as a bridge or router between module 120 and network 160. In order to communicate with module 120, access point 150 may also utilize any of the various wireless protocols known in the art. In one embodiment, access point 150 is a DHCP server, permitting dynamic assignment of IP addresses to module 120. It will be appreciated that wireless link 135 can be implemented as any suitable wireless network, such as a WLAN, conforming to a wireless protocol known in the art.

Network 160 can be a Local Area Network (LAN), Intranet, the Internet, and/or any other suitable network capable of exchanging electronic information between access point 150 and one or more remote devices 170 in accordance with the present invention.

As illustrated in FIG. 1, remote device 170 is in communication with network 160. Remote device 170 can be any suitable device capable of exchanging and processing electronic information in accordance with the present invention. For example, device 170 can be a personal computer running a Windows™-based, or other suitable operating system. It will be appreciated that a plurality (not shown) of remote devices 170 in communication with network 160 can also be provided in accordance with the present invention.

In one embodiment, remote device 170 is capable of running a browser application 180 which can be any software application used for communicating over the Internet. By communicating with module 120 over network 160 and wireless link 135, browser 160 can be used to access data provided by host 110 through module 120, as further described herein. In certain embodiments, browser 180 is also capable of configuring module 120, as also described herein. In another embodiment, device 170 is capable of running a user-operable configuration utility 190 for remotely configuring module 120.

When a plurality of remote devices 170 are provided as described above, module 120 can be implemented such that module 120 is capable of selectively communicating with each remote device 170, one at a time. By performing relatively brief communications between module 120 and the various remote devices 170, the appearance of simultaneous, concurrent access to module 120 and/or host 110 by such remote devices 170 can be achieved. It is further contemplated that different combinations of browser 180, utility 190, and/or other applications can be run on individual remote devices 170 of the plurality of remote devices 170. For example, it will be appreciated that browser 180, utility 190, and/or other applications need not be implemented on a single remote device 170. Rather, each can be implemented separately, or in any desired combination, on one or more remote devices 170 of the plurality of remote devices 170. It will also be appreciated that, in various embodiments, a remote device 170 can operate as a remote client or server, as appropriate.

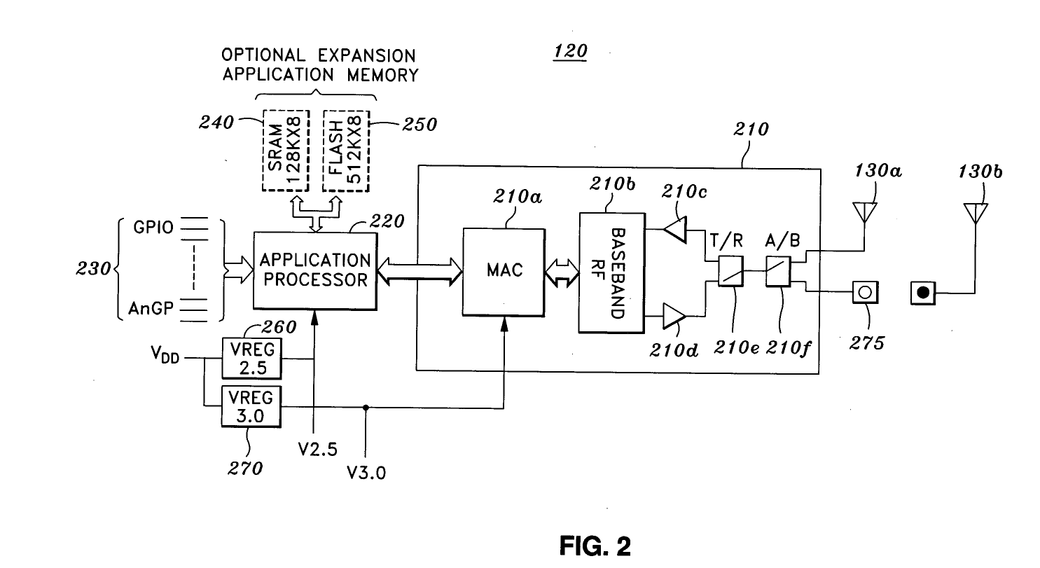

FIG. 2 is a block diagram illustrating various components of module 120 in accordance with an embodiment of the present invention. Although module 120 is described in FIG. 2 and other figures herein in the context of the IEEE 802.11b wireless standard, it will be appreciated that module 120 can be implemented in accordance with any suitable wireless protocol known in the art.

Module 120 incorporates a wireless radio 210 supporting a wireless networking protocol. Radio 210 includes a media access control (MAC) 210a that provides for and manages all time-critical wireless media control for the module. In one embodiment, MAC 210a can be implemented on a chip, for example, the Intersil Corporation ISL 3871. It will be appreciated that other embodiments of MAC 210a are also contemplated in accordance with the present invention.

Radio 210 also includes a baseband RF block 210b for providing all appropriate baseband signal processing as well as appropriate RF modulation for wireless communication between module 120 and access point 150. In one embodiment, baseband RF 210b can be implemented on a chip, for example, the Intersil Corporation ISL 3684. It will be appreciated that other embodiments of baseband RF 210b are also contemplated in accordance with the present invention.

Radio 210 further includes preamplifier 210c and power amplifier 210d for amplifying signals received by and transmitted from module 120, respectively. Transmit/receive switch 210e selects a signal path for either transmit or receive functions, and can be automatically controlled by MAC 210a.

Antenna selection switch 210f controls whether internal antenna 130a or optional external antenna 130b is used for wireless communication. Switch 210f can also be automatically controlled by MAC 210a. Internal antenna 130a and optional external antenna 130b illustrate various embodiments of antenna 130 set forth in FIG. 1. Internal antenna 130a can be provided for implementations where host 110 does not interfere with RF propagation from module 120. Alternatively, external antenna 130b can be provided in embodiments where host 110 does interfere with such RF propagation, such as when module 120 is embedded in a host 110 having an enclosure that causes such interference. External antenna 130b can be attached to module 120 by connector 275.

Application processor 220 supports the operation of module 120. In one embodiment, processor 220 can be implemented by, for example, a Ubicom, Inc. IP2022™ Wireless Network Processor. It will be appreciated that other embodiments of processor 220 are also contemplated in accordance with the present invention. Firmware of processor 220 supports a 802.11b network driver, as well as a TCP/IP protocol stack and features required for Internetworking. Of the 120 MIPS provided by this embodiment of processor 220, 30 MIPS are typically available for customer-specific applications. In this embodiment, processor 220 has 64 KB program flash memory, 16K program RAM, and 4 KB data RAM integrated on-chip. Optional expansion application memory, such as SRAM 240 and FLASH 250 can also be provided for operation in conjunction with processor 220 as illustrated in FIG. 2.

Module 120 also provides a plurality of physical ports 230 for communicating with host 110. It will be appreciated that a variety of physical input and output ports 230 can be implemented to facilitate the integration of module 120 into a wide range of hosts 110 for analog and/or digital applications. In one embodiment, the physical ports 230 are under software control and are implemented as twelve (12) 5V tolerant General Purpose I/O lines (GPIO) and eight (8) 3.3V max Analog input/Digital I/O lines (AnGP or AIN). The GPIO lines can also be configured through a high-speed SERDES to support high speed synchronous or asynchronous serial, Ethernet, USB, or SPI communication. Additionally, free GPIO lines can be configured to support low-speed asynchronous serial, SPI, 12C, and SMB interfaces or switches and indicators.

The main I/O function of each of physical ports 230, as well as the dedicated function for the various SERDES configurations for an embodiment of the present invention are illustrated in the following Table 1.

TABLE 1

| Port | I/O | Serial | Ethernet(1) | Ethernet(2) | USB | SPI | GPIO |
|---|---|---|---|---|---|---|---|
| E4 | GPIO | — | — | TXD+ | — | — | — |
| E5 | GPIO | — | — | TX+ | — | — | — |
| E6 | GPIO | — | — | TX− | — | — | — |
| E7 | GPIO | — | — | TXD− | — | — | — |
| F0 | GPIO | — | TxD+ | — | OE | — | RxEN |
| F1 | GPIO | RXD | TX+ | — | VPO | SDO | RxD |
| F2 | GPIO | — | TX− | — | VMO | — | TxCLK |
| F3 | GPIO | — | TxD− | — | — | — | TxBUSY |
| F4 | GPIO | — | — | — | — | SCLK | RxCLK |
| F5 | GPIO | — | — | — | VP | SS | TxEN |
| F6 | GPIO | — | — | — | VM | — | — |
| F7 | GPIO | TXD | — | — | RCV | SDI | TxD |
| G0 | AnGP | — | — | — | — | — | — |
| G1 | AnGP | — | — | — | — | — | — |
| G2 | AnGP | — | — | — | — | — | — |
| G3 | AnGP | — | — | — | — | — | — |
| G4 | AnGP | — | — | RX− | — | — | — |
| G5 | AnGP | — | — | RX+ | — | — | — |
| G6 | AnGP | — | RX− | — | — | — | — |
| G7 | AnGP | — | RX+ | — | — | — | — |

With regard to the embodiment set forth in Table 1 above: ports that are not dedicated to a selected SERDES function are GPIO or AnGP; the USB interface can operate in either Host or Device mode; the SPI interface can operate in either Master or Slave Mode; the GPIO can operate in either Master or Slave Mode; and the Ethernet(2) configuration can be used concurrently with any of the other SERDES or I/O functions.

In another embodiment, GPIO and AnGP physical ports 230 can be used to implement other interfaces under firmware control. Table 2 below lists several interfaces which can be implemented, and the number of ports used for such implementation. It will be appreciated that firmware support for other interfaces may also be provided.

TABLE 2

| Interface | No. of GPIO/AnGP ports |
|---|---|
| UART | 2 |
| (19.2 Kbps max) | |
| RS-232 Hardware | 6 |
| Flow Control | |
| I2C Master | 2 |
| SPI Master | 4 |

In another embodiment, the I/O configuration of physical ports 230 is implemented in five I/O groups as set forth in Table 3 below. Each row of Table 3 represents one of physical ports 230. Within each group, only one of the columns may be selected at a time:

TABLE 3

| | Group 2 | | Group 3 | | | Group 4 | | | | |
|---|---|---|---|---|---|---|---|---|---|---|
| Group 1 | HS | | LS | | | LS SPI | I2C | | Group 5 | |
| Digital | UART | HS SPI | UART | Digital | Analog | Master | Master | Digital | Digital | Analog |
| GPIO1 | | | | | | | | | | |
| GPIO2 | | | | | | | | | | |
| GPIO3 | | | | | | | | | | |
| GPIO4 | | | | | | | | | | |
| | | | | | | LSDO | SCL | GPIO5 | | |
| | HRXD | HSDO | | | | | | | | |
| | | | | | | LSCLK | GPIO7 | GPIO7 | | |
| | | | | | | LSEL | GPIO8 | GPIO8 | | |
| | HRTS | HSCLK | | | | | | | | |
| | HCTS | HSEL | | | | | | | | |
| | | | | | | LSDI | SDA | GPIO11 | | |
| | HTXD | HSDI | | | | | | | | |
| | | | | | | | | | GPIO13 | AIN1 |
| | | | | | | | | | GPIO14 | AIN2 |
| | | | | | | | | | GPIO15 | AIN3 |
| | | | | | | | | | GPIO16 | AIN4 |
| | | | LRTS | GPIO17 | AIN5 | | | | | |
| | | | LCTS | GPIO18 | AIN6 | | | | | |
| | | | LRXD | GPIO19 | AIN7 | | | | | |
| | | | LTXD | GPIO20 | AIN8 | | | | | |

In addition, some GPIO lines of physical ports 230 can be configured to implement special functions, rendering them unavailable as GPIO bits. Examples of such special functions are set forth in the following Table 4:

TABLE 4

| Function Name | Description |
|---|---|
| Active On | Set true when the module is active and |
| | functioning |
| Active Flashing | Indicates start-up error or device does |
| | not have an IP address |
| RF Link | Set true when radio establishes a |
| | wireless link |
| Activity | Toggles in sympathy with data transmission |
| | activity |
| Connect | Set true when an IP connection is active |

Module 120 can also be provided with an additional Test SPI interface (not shown) used for development and manufacturing purposes and for downloading firmware of module 120. In one embodiment, the Test SPI interface is implemented using the following signals set forth in Table 5:

TABLE 5

| Signal | Direction | Description |
|---|---|---|
| /TSS | In | Test Slave Select (Active Low) |
| TSCK | In | Test SPI Clock |
| /TRST | In | Test RESET (Active Low) |
| TSI | In | Test Serial Data In |
| TSO | Out | Test Serial Data Out |

Referring again to FIG. 2, a power supply V_{DD} for module 120 is also provided. In one embodiment, V_{DD} is a single voltage source in the range of 3.3 to 6 VDC which can provide current up to approximately 400 mA for transmission bursts. Linear voltage regulators 260 and 270 provide 2.5 V and 3.0 V power, respectively, to various components of module 120 as illustrated in FIG. 2. Additionally, voltage regulator 260 may source up to 25 mA to be used as an analog reference voltage for analog signals input to physical ports 230. In various embodiments, module 120 can also be implemented to support low power modes (Sleep, Doze, Scan, Active) that are partially supported in hardware, with software enabling all features.

In various embodiments, the mechanical packaging of module 120 can be implemented as: (1) a single board that forms the completely integrated module; or (2) a two-board stacked version with one board including the radio and baseband processor, and a second board containing the application processor and I/O interface.

Module 120 can also be implemented in accordance with the following specifications of Table 6:

TABLE 6

| Functionality | Specification |
|---|---|
| Radio Technology | IEEE 802.11b Direct Sequence |
| | Spread Spectrum |
| Operating Frequency | 2400-2497 MHz ISM band |
| Modulation Schemes | DQPSK, DBPSK and CCK |
| Channel Numbers | IEEE 802.11b compliant |
| | 11 channels for United States |
| | 13 channels for Europe |
| | 14 channels for Japan |
| Data Rate | 11 Mbps with fall back rates of |
| | 5.5, 2 and 1 Mbps |
| Media Access Protocol | CSMA/CA with ACK, RTS, CTS |
| Transmitter Output Power | 17 dBm (typ.) |
| Receiver Sensitivity | Min. −82 dBm for 11 Mbps |
| | Min. −88 dBm for 2 Mbps |
| Security | Supports wireless data encryption |
| | with 40 bits/128 |
| | bits WEP standard for security |
| Antenna Type | Integrated antenna |
| | Optional external antenna |
| Operating Voltage | 3.3 to 6 VDC |
| Current Consumption | 400 mA at transmit mode (max) |
| | 300 mA at receive mode (typ.) |
| | 100 mA at sleep mode (typ.) |

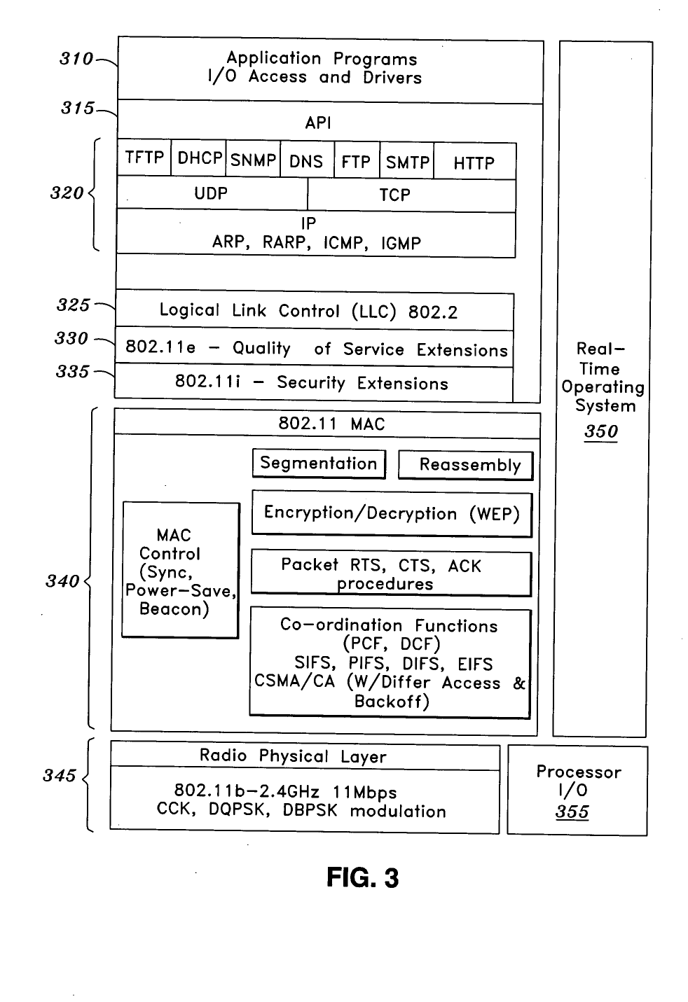

FIG. 3 is a block diagram illustrating the software architecture of module 120 in accordance with an embodiment of the present invention. Application programs 310 are executed by processor 220 of module 120 for controlling the operation of module 120, and for implementing I/O access and drivers. An application program interface (API) 315 allows programs 310 to interface with the various protocols 320 known in the art, in order to facilitate the communication of module 120 with other components of the system of FIG. 1. Logical link control 325 allows processor 220 to interface with MAC 210a of radio 210. Optional quality of service extensions 330 and optional security extensions 335 can also be provided to support IEEE 802.11 wireless standards.

Additional software 340 and 345 of module 120 can be implemented by the combination of MAC 210a and baseband RF 210b of radio 210. Software 340 implements an 802.11 MAC layer and provides many of the standard functions necessary for wireless networking, including: segmentation and reassembly of packets, encryption/decryption, MAC Control (including synchronization, beacon, and controlling the power of the module wireless output signal), and baseband functions (including the functionality illustrated in the packet procedures and co-ordination functions blocks). Software 345 supporting the radio physical layer 345 can also be provided, as illustrated in FIG. 3. The realtime operating system 350 of processor 220, as well as the software representation 355 of physical ports 230 are also illustrated.

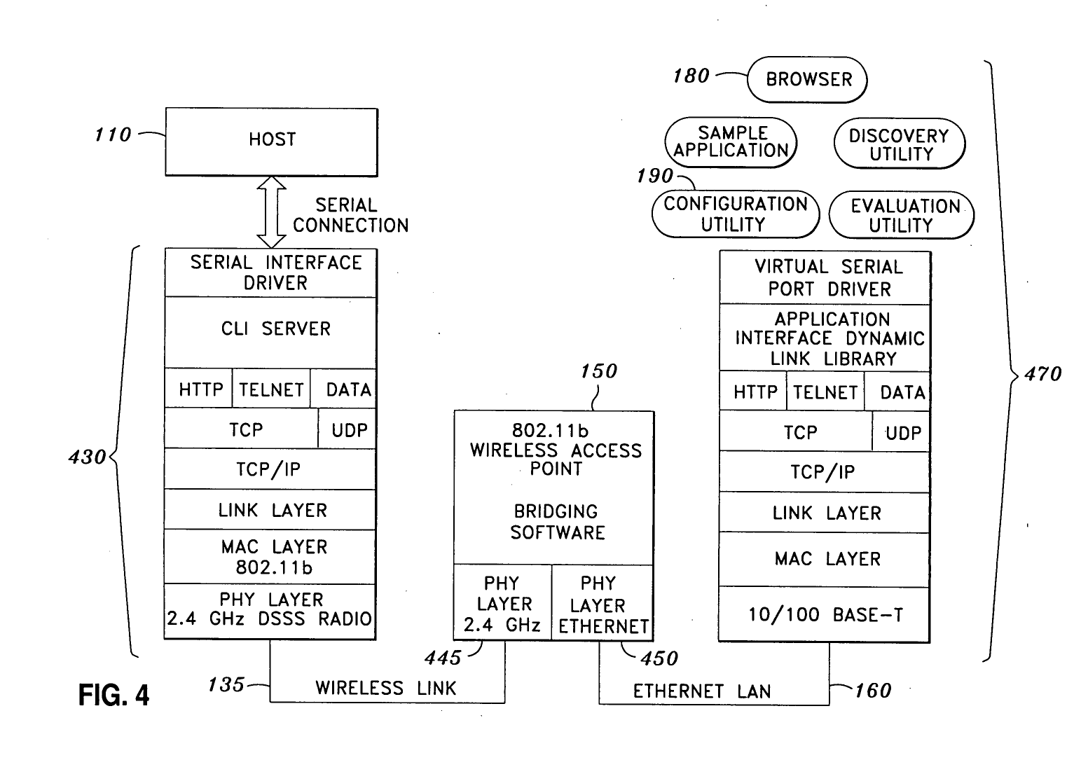

FIG. 4 is a block diagram illustrating various software components of module 120, access point 150, and remote device 170 used for exchanging data in accordance with an embodiment of the present invention. The software components of FIG. 4 can provide for the orderly transfer of data between components of the system of FIG. 1 using standardized protocols and processes, where applicable. The software components also provide a platform to permit data communication with a variety of hosts 110 through industry standard physical ports 230 of module 120. Although FIG. 4 illustrates a particular software implementation (i.e. the use of IEEE 802.11b standard, 2.4 GHz DSSS radio, Ethernet LAN network), it will be appreciated that other implementations using different specifications are contemplated by the present invention.

In the block diagram, data from host 110 is received by module 120 through a serial interface connection between host 110 and module 120. The data is passed through any appropriate combination of the layers and software components (collectively illustrated as element 430) implemented on module 120, and sent over wireless link 135. It will be appreciated that the HTTP and Telnet layers of module 120 provide for the implementation of a web server and Telnet server, respectively, on module 120. In one embodiment, all web page requests to module 120 are handled by the web server of module 120. It will also be appreciated that the data layer of module 120 provides a conduit for other data connections through module 120.

Data is received by access point 150 (implemented as a bridge in FIG. 4) through physical layer 445 and passed through bridging software and physical layer 450 to network 160. Remote device 170 in communication with network 160 receives the data and passes it through any appropriate combination of the layers and software components (collectively illustrated as element 470) implemented on remote device 170, thus permitting remote device 170 to communicate with host 110 through module 120. It will also be appreciated that data can be transferred in the reverse direction, allowing remote device 170 to send data to host 110.

In another aspect of the present invention, module 120 permits a browser 180 of remote device 170 to request and receive data from host 110, and display the data to a user of remote device 170 as an HTML-formatted web page. For example, if host 110 is implemented as a remote sensor, the sensor data can be requested and displayed to a user of browser 180.

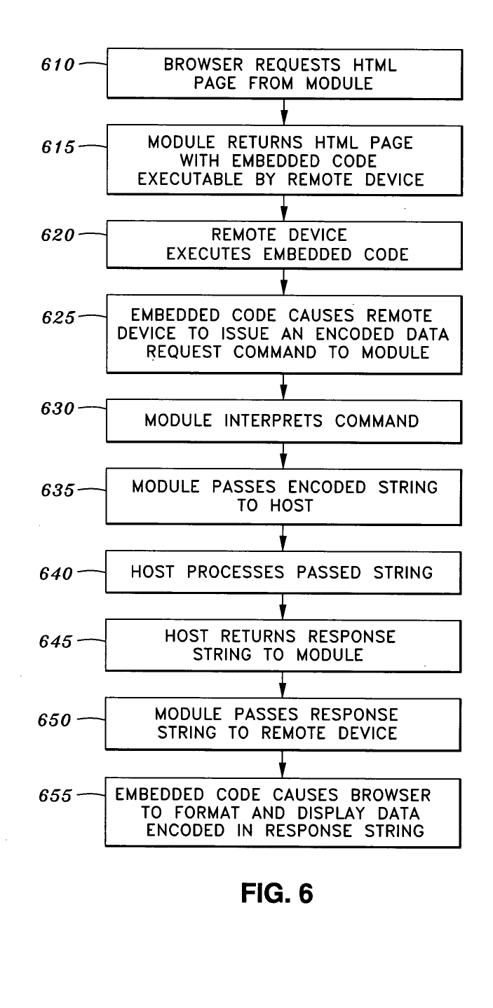

FIG. 6 is a flowchart describing a process for performing such browser-based data communication between remote device 170 and host 110. At step 610, browser 180 of remote device 170 requests an HTML page from module 120. It will be appreciated that the request of step 610 can be in any format that complies with the TCP/IP protocol, such as an HTTP “get” command issued to the IP address of module 120. Upon receipt of the request, module 120 returns an HTML page to browser 180 in step 615. The HTML page can have embedded code, such as JavaScript, that is executable by remote device 170. In one embodiment, step 615 is performed by the web server of module 120.

In step 620, remote device 170 executes the embedded code which causes remote device 170 to issue a data request command to module 120, wherein the command includes an encoded string (step 625). The string can be encoded in accordance with a host-oriented protocol or other appropriate protocol such that, when the string is processed by host 110, it will be recognized by host 110 as a data request. For example, in one embodiment, the encoded string can be an ASCII string encoded in accordance with a coding scheme determined by an OEM provider of host 110.

Module 120 interprets the command (step 630) and passes the encoded string to host 110 (step 635). Host 110 processes the string (step 640) and returns a response string to module 120 (step 645). The response string can be in the form of HTML blocked data to be processed by the embedded code executing on remote device 170. Upon receipt of the response string, module 110 passes the response string to remote device 170 (step 650). Embedded code executing on the remote device 170 then causes browser 180 to format and display the data encoded in the response string (step 655).

In various embodiments, the embedded code is expected to include code that issues HTTP “put” or “get” commands that may include CLI putget or putexpect commands (further described herein) to obtain content for web pages from the host 110. If it is desired that module 120 and host 110 be readily available to provide data from host 110 to browser 180, or be readily available to interact with other connections, any connection initiated by the embedded code should be kept open for as a short a time as possible, in order to permit other traffic to easily interleave between requests issued by the embedded code.

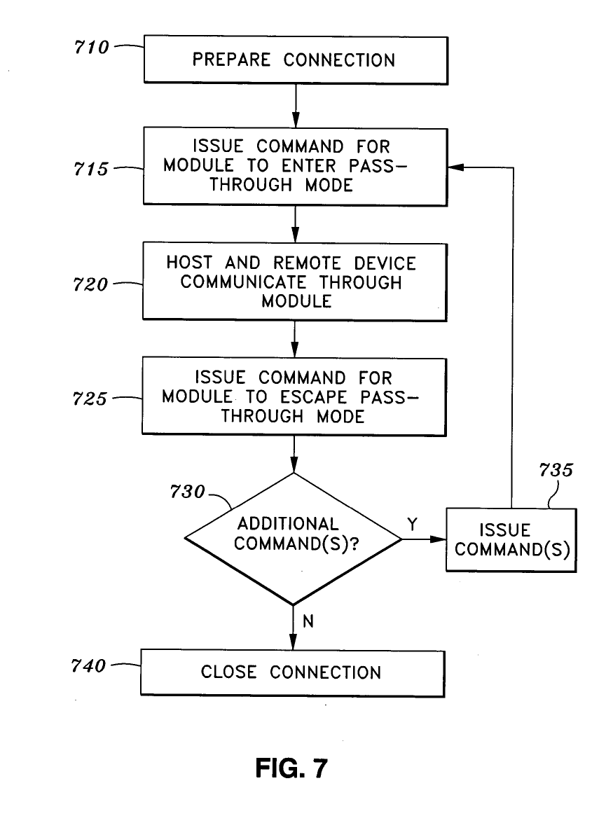

In another aspect of the present invention, module 120 facilitates data communication between remote device 170 and host 110 using a pass-through mode initiated by commands issued by remote device 170 or host 110. FIG. 7 is a flowchart describing a process for performing such command-based data communication using such a pass-through mode. At step 710, a connection (for example, a TCP connection) between module 120 and remote device 170 is prepared. After the connection is prepared, either remote device 170 or host 110 issues a command for module 120 enter a “pass-through” mode (step 715) wherein remote device 170 and host 110 can communicate with each other through module 120 (step 720). It will be appreciated that, in various embodiments, this pass-through mode of module 120 can be interpreted as the operation of a serial interface of module 120 in a pass-through mode, as further described herein.

While module 120 is in pass-through mode, module 120 passes raw data received from wireless link 135 directly to host 110, and passes raw data received from host to the wireless link, without interpreting the data passed in either direction. However, while in pass-through mode, module 120 can still interpret a command to escape the pass-through mode (step 725).

After module 120 has escaped pass-through mode, additional commands can be issued to module 120 (step 730). If one or more additional commands are issued (step 735), the process returns to step 715 after such issuance. If no additional commands are to be issued, then the connection between module 120 and remote device 170 is closed (step 740).

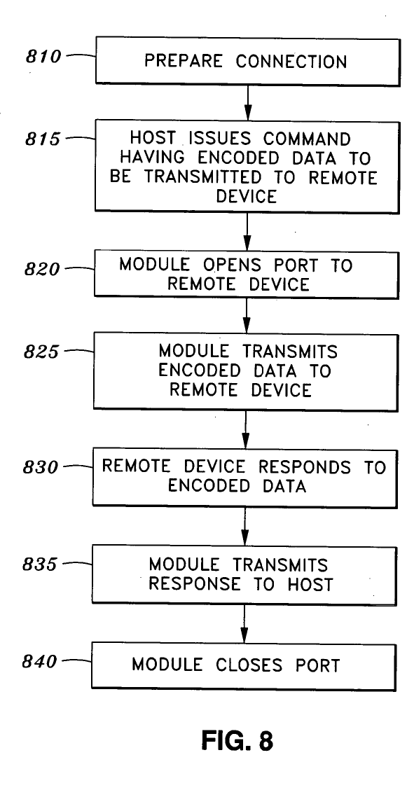

In another aspect of the present invention, module 120 facilitates the communication of host 110 with remote device 170 by way of commands issued by host 110 to module 120 in accordance with an alternate process. FIG. 8 is a flowchart describing a process for performing such host-initiated command-based data communication. At step 810, a connection (for example, a TCP connection) between module 120 and remote device 170 is prepared.

After the connection is prepared, host 110 issues a command to module 120 having encoded data to be transmitted to remote device 170 (step 815). It will be appreciated that the encoded data in the command of step 815 can be a string encoded in accordance with a host-oriented protocol or other appropriate protocol such that, when the string is processed by remote device 170, it will be recognized as a data request.

Upon receipt of the command, module 120 opens a port to remote device 170 (step 820) and transmits the encoded data to remote device 170 (step 825). Remote device 170 then responds to the encoded data by returning response data to module 120 (step 830). It will be appreciated that the response data can also be a string encoded in accordance with a host-oriented protocol or other appropriate protocol as previously described herein such that, when the string is processed by host 110, it will be recognized by host 110 as a response to the encoded data contained in the command of step 815. Upon receipt of the response data, module 120 transmits the response data to host 110 (step 835) and closes the port (step 840).

It will be appreciated that the steps of FIG. 8 can permit host 110 to use module 120 for performing data communication with remote device 170, without requiring the host 110 to have knowledge of the particular protocols used by module 120 to communicate with remote device 170. It will also be appreciated that a port is opened and closed for each instance in which host 110 desires to perform a send/receive operation with remote device 170. Accordingly, the steps of FIG. 8 can be repeated for additional send/receive operations.

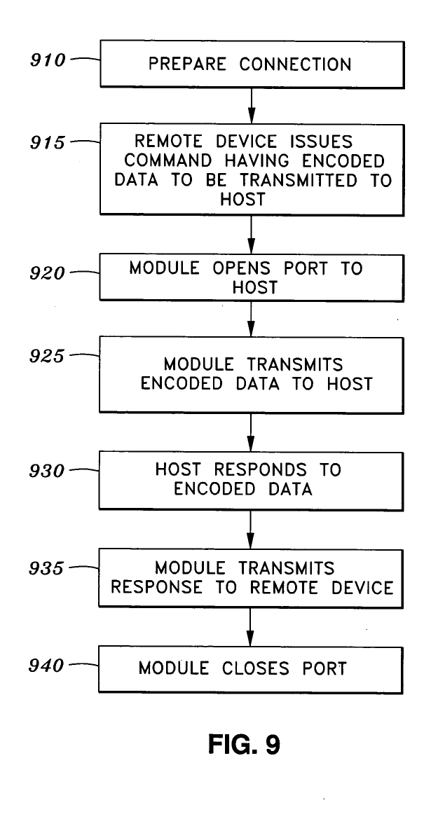

In another aspect of the present invention, module 120 facilitates the communication of remote device 170 with host 110 by way of commands issued by remote device 170 to module 120 in accordance with an alternate process. FIG. 9 is a flowchart describing a process for performing such remote device-initiated command-based data communication. At step 910, a connection (for example, a TCP connection) between module 120 and remote device 170 is prepared. After the connection is prepared, remote device 170 issues a command to module 120 having encoded data to be transmitted to host 110 (step 915). It will be appreciated that the encoded data in the command of step 915 can be a string encoded in accordance with a host-oriented protocol or other appropriate protocol, as previously described herein such that, when the string is processed by host 110, it will be recognized by host 110 as a data request.

Upon receipt of the command, module 120 opens a port to host 110 (step 920) and transmits the encoded data to host 110 (step 925). Host 110 then responds to the encoded data by returning response data to module 120 (step 930). It will be appreciated that the response data can be formatted as a string that is encoded in accordance with a host-oriented protocol or other appropriate protocol such that, when the string is processed by remote device 170, it will be recognized by remote device 170 as a response to the encoded data contained in the command of step 915. Upon receipt of the response data, module 120 transmits the response data to remote device 170 (step 935) and closes the port (step 940).

It will be appreciated that the steps of FIG. 9 permit remote device 170 to use module 120 for performing data communication with host 110, without requiring the host 110 to have knowledge of the particular protocols used by module 120 to communicate with remote device 170. It will also be appreciated that a port is opened and closed for each instance in which remote device 170 desires to perform a send/receive operation with host 110. Accordingly, the steps of FIG. 9 can be repeated for additional send/receive operations. Moreover, when the process of FIG. 9 is commanded through a Telnet session, step 940 can be skipped.

In another aspect of the present invention, module 120 can support a comprehensive set of configuration parameters for customizing the operation and implementation of the module 120. Parameters can be implemented to support read, write, or read/write status. In various embodiments, the configuration parameters can be adjusted in a variety of ways, such as through the issuance of commands (for example, CLI commands) by host 110 or remote device 170, by browser 180 through an HTML page served by module 120, and/or by configuration utility 190. Authentication can be required for the adjustment of various parameters, and certain parameters can be implemented such that adjustment is only permitted at the factory. Various combinations of these adjustment methods may also be used.

The following Table 8 lists a set of configuration parameters that can be implemented in a particular embodiment of module 120. It will be appreciated that the support of a “Hardware I/O Configuration” parameter, as well as those parameters listed thereafter in Table 8, constitute additional unique features of module 120 in relation to prior art designs.

TABLE 8
Parameter

OEM access key
Admin Login ID
Admin Login Password
Ad Hoc or Infrastructure Mode
Region (USA, Japan, Europe)
802.11b channel number, or Auto
Antenna Selection
SSID - Wireless LAN ID
Power Management - Off, On, Sleep, Doze, Scan, Active
Data Rate - 1, 2, 5.5, 11 Mbps, Auto
OEM assigned MAC address
DHCP obtained IP address
Specific IP Address
Subnet Mask
DNS
WINS
Authentication type
WEP - Enabled/Disabled
WEP - 64 bit or 128 bit selection
WEP keys - up to 4 WEP keys
Data & Time or get from LAN/Internet
Advanced WLAN parameters
Advanced - RTS Threshold
Advanced - Fragmentation Threshold
Advanced - DTIM Interval
Advanced - Preamble Type - Short or Long
Advanced - Traffic & status logging - enable/disable
Advanced - Report and/or Clear Log
Scan Mode - scan for APs/Hotspots
Scan Mode - login ID
Scan Mode - login password
Hardware I/O Configuration
GPIO - UDP, TCP, HTTP
GPIO - report rate (ms)
GPIO - report on event
GPIO - events - change, rising, falling per input bit
GPIO - data direction per bit
GPIO - debounce on/off per input bit
AIN - UDP, TCP, HTTP
AIN - report rate (ms)
AIN - report on event
AIN - sample rate - Ksps
AIN - digital filter smoothing
AIN - events - window comparison hi-lo thresholds, change
threshold
Serial -HS, LS, HSSPI
Serial - baud rate
Serial - handshake - HW, SW, None

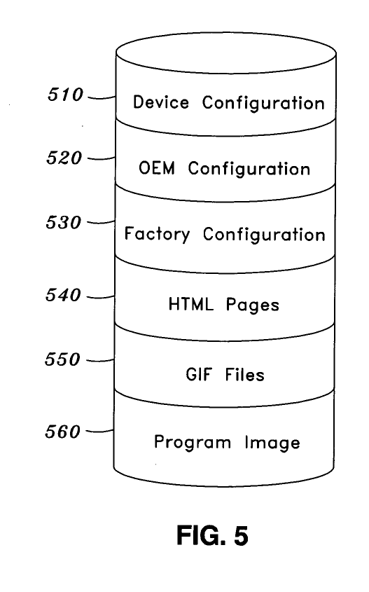

In one embodiment, the configuration parameters are divided into three capability sets stored in flash memory of processor 220: (1) device configuration parameters; (2) OEM configuration parameters; and (3) factory configuration parameters. FIG. 5 is a block diagram providing a conceptual illustration of the contents of flash memory files in such an embodiment.

Referring to FIG. 5, device configuration parameters 510 can be set at the installation/deployment of module 120 with a host 110. Such parameters can include: all HTML pages and fields parameters (values), IP address and related network and IP parameters, I/O configuration, wireless parameters, and device access key.

OEM configuration parameters 520 can be modified and configured by an OEM in order to customize module 120 for use with a particular host 110 provided by the manufacturer. For example, such OEM configuration parameters can specify: HTML pages and fields permissions, command permissions, product ID, OEM ID, OEM defaults, and OEM access key (permanent, random, host assigned). In particular, the OEM configuration parameters can configure the HTML pages and GIF files served by module 120 when a browser 180 accesses a host 110 provided by the OEM.

Factory configuration parameters 530 specify the base configuration of module 120 that is loaded into flash memory from the program image 560 (firmware) of the module, and cannot be subsequently changed by an OEM receiving the module. The factory configuration 530 can be dynamically reloaded as desired. Such factory configuration parameters can adjust: functional permissions, MAC address, version and date codes, manufacturer ID, factory defaults for all fields and parameters, factory access key, hardware configuration definition, and which tools can be used to adjust other parameters (i.e. browser, commands, configuration utility).

HTML pages 540 and GIF files 550 are also stored in flash memory. Various HTML pages 540 and GIF files 550 can be provided, having different purposes. For example, when host 110 is accessed by browser 180 through module 120 as in FIG. 6, appropriate HTML pages 540 and GIF files 550 can be served to browser 180 to facilitate such data communication. As another example, if parameters (such as configuration parameters) and/or status of module 120 are sought to be accessed by browser 180 (for instance, to adjust configuration parameters of module 120), other appropriate HTML pages 540 and GIF files 550 can be served to browser 180 to facilitate such access. The content of HTML pages 540 and GIF files 550 can be modified by an OEM operating a configuration utility 190 as further described herein.

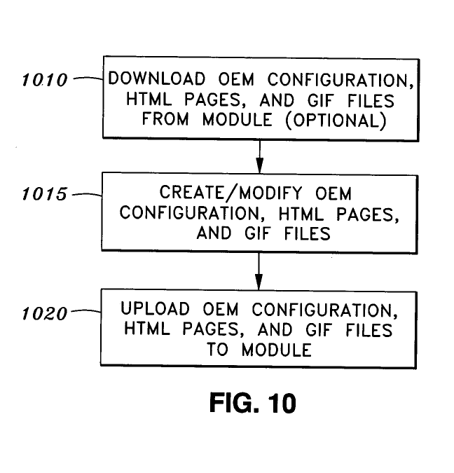

FIG. 10 is a flowchart describing a process for configuring module 120 over wireless link 135 using configuration utility 190 of remote device 170. By using the configuration utility 190, an OEM can create and/or modify the OEM configuration 520, and generate a downloadable configuration file for the module.

In optional step 1010, configuration utility 190 downloads a pre-existing OEM configuration 520, HTML pages 540, and GIF files 550 from module 120 over wireless link 135. A user of remote device 170 can then modify the downloaded OEM configuration 520, HTML pages 540, and GIF files 550, or create a new OEM configuration, HTML pages, and/or GIF files using configuration utility 190 (step 1015).

During step 1015, the user can modify any of the configuration parameters in the OEM configuration 520 as well as parameters for, and content of, HTML pages 540 and GIF files 550 served by module 120 for browser-based data communication with host 110, as previously described above. In one embodiment, the modified data is in the format of a binary configuration file. At step 1020, the configuration utility 190 uploads the modified or new OEM configuration, HTML pages, and GIF files to module 120 over wireless link 135.

To secure against the execution of unauthorized commands, module 120 can provide authentication security. Authentication can be implemented in the form of a user ID and password sent to module 120. For example, in one embodiment, access to module 120 from remote device 170 using Telnet, HTTP, or TCP over wireless link 135 can be authenticated. In other embodiments, authentication can be applied to access to module 120 from host 110. It will be appreciated that various authentication implementations are contemplated, wherein authentication is applied to some, all, or none of the access to module 120 from host 110 and/or remote device 170. It is further contemplated that authentication need not be applied at all times. For example, it may be desirable that authentication not be performed when module 120 is in a pass-through mode. Depending on the password used for authentication, a security/access level is determined. The terms “access level” and “security level” are used interchangeably herein.

In one embodiment, each CLI command recognized by module 120 corresponds to one of five (5) security levels: Level 0 (L0) UDP security; Level 1 (L1) default security; Level 2 (L2) device configuration security; Level 3 (L3) OEM security; and Level 4 (L4) manufacturer security. Level 0 is a connectionless access level pertaining to access to module 120 over UDP and access to name query services. Level 0 commands can be executed without requiring authentication. Level 1 is the default security level for module 120 when power is applied.

Authentication for a particular security level permits the execution of CLI commands requiring the same security level, as well as CLI commands having lower security levels. For example, an authentication using a valid Level 2 user ID and password would permit the execution of CLI commands having security Levels 0, 1, and 2, but would not permit the execution of CLI commands having security Levels 3 or 4.

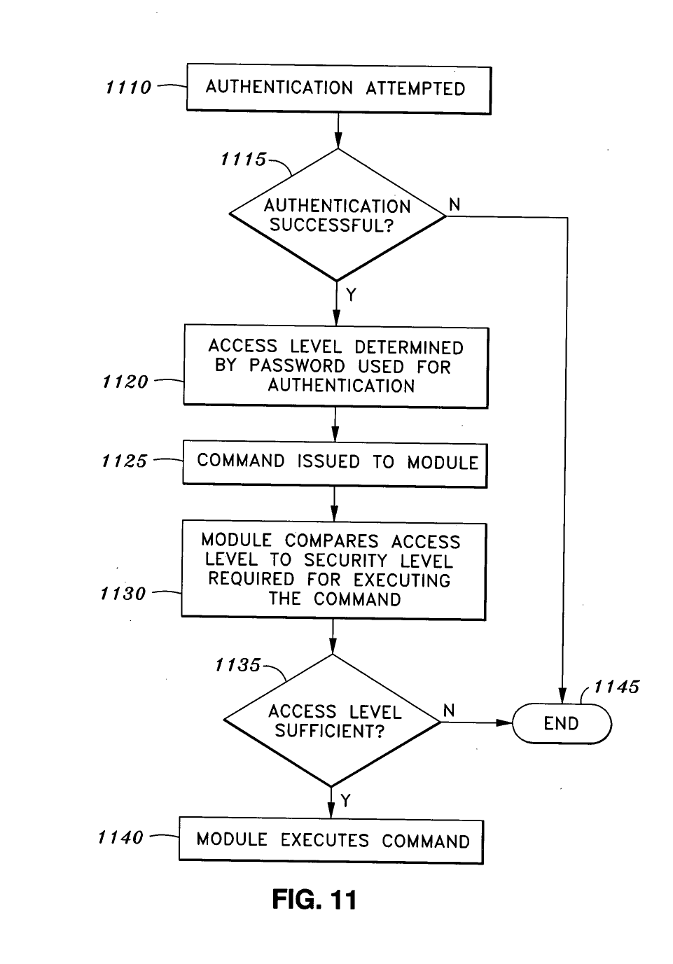

FIG. 11 is a flowchart describing a process for authenticating commands issued to a module in accordance with an embodiment of the present invention. At step 1110, either host 110 or remote device 170 attempts to authenticate with module 120 through the issuance of an authentication command to module 120. If no valid login is performed, then the authentication will be deemed to be unsuccessful (step 1115), and the process of FIG. 11 ends (step 1145). If, however, a valid login is performed (step 1115), then the authenticating device will be granted an access level determined by the password used for authentication (step 1120). At step 1125, the authenticated device issues a command to module 120. Upon receipt of the command, module 120 compares the access level granted to the authenticated device with the security level required for executing the command (step 1130). If the device access level is sufficient (step 1135), module 120 proceeds to execute the command (step 1140). If the access level is insufficient (step 1135), the process of FIG. 11 ends (step 1145).

To facilitate the operation of module 120 as described herein, module 120 can be implemented to recognize and execute commands received from remote device 170 over wireless link 135 and/or from host 110. Various commands can be used to configure, control, and obtain status of module 120, and set up communications via module 120. The commands issued to module 120 can be of any suitable format that can be interpreted and processed by the module. For example, such commands can be implemented using a command line interface (CLI).

Module 120 can implement a variety of responses to CLI commands it receives, depending on the nature of the command and success or failure of the command. For example, module 120 can return a response formatted as “OK” which indicates the successful execution of a CLI command. Similarly, module 120 can return an error response, having the general format: “Error 0xhhhh: error text” where the aschex value is the error code. In one embodiment, all responses are followed by <CRLF>.

In one embodiment, the CLI commands of the following Tables 9A-H can be employed. It will be appreciated that the “Ln” column indicates the security level corresponding to each command, as further described herein.

TABLE 9A
Module IP Configuration Commands

| Command | CLI Arguments | Ln | Description |
|---|---|---|---|
| wl-dhcp | [integer] | L2 | DHCP client enable or disable |
| | | | 0 = disable |
| | | | 1 = enable (default) |
| wl-ip | [integer] | L2 | Static IP address if DHCP client |
| | | | is disabled. 32 bit unsigned |
| | | | long. Default = 0xC0A80163. |
| wl-subnet | [integer] | L2 | Static subnet mask if DHCP client |
| | | | is disabled. 32 bit unsigned |
| | | | long. Default = 0xFFFFFF00. |
| wl-gateway | [integer] | L2 | Static default gateway/router |
| | | | IP address. 32 bit unsigned |
| | | | long. Default = 0x00000000. |
| wl-hostname | [string] | L2 | Host name for DHCP client |
| | | | [64 chars max]. Default = |
| | | | “HOST 1101”. |
| wl-udap | [integer] | L2 | UDAP discovery enable or disable |
| | | | 0 = disable |
| | | | 1 = enable (default) |

TABLE 9B
Wireless Configuration Commands

| Command | CLI Arguments | Ln | Description |
|---|---|---|---|
| wl-mac | [binary] | L3 | Wireless Ethernet MAC. Six |
| | | | bytes aschex. Default = |
| | | | “00506E00000B”. USE with |
| | | | extra caution. |
| wl-type | [string] | L2 | Network type: |
| | | | a = Access Point |
| | | | (Infrastructure) default |
| | | | p = Peer-to-peer (Ad hoc) |
| wl-ssid | [string] | L2 | SSID [31 chars max]. |
| | | | Default = “wlandemo”. |
| wl-chan | [integer] | L2 | Channel number - only peer-to-peer |
| | | | Channels range: 1-14, |
| | | | default = 1. |
| wl-wep | [integer] | L2 | WEP security - number of bits: |
| | | | 0 = disabled (default), |
| | | | 64 or 128 |
| wl-key | [integer] [binary] | L2 | Set WEP key n (1-4) to |
| | | | binary value |
| | | | [10 or 26 hex digits]. |
| | | | Default = “”. |
| wl-ant | [integer] | L3 | Antenna selection: |
| | | | 0 = Ant1 (default) |
| | | | 1 = Ant2, |
| | | | 2 = Both (diversity) |
| wl-scan | | L2 | Scan for Access Points |
| | | | and report status. |
| | | | Status report for each found |
| | | | AP is as follows: |
| | | | scan reason: 3 |
| | | | channel: 7 |
| | | | average noise: 9 |
| | | | signal level: 46 |
| | | | BSSID: 0006255D537D |
| | | | beacon interval: 100 |
| | | | capabilities: 0x1 |
| | | | SSID: FirstAccessPoint |
| | | | rate: 5120 (Kb/s) |
| | | | channel: 4 |
| | | | average noise: 9 |
| | | | signal level: 46 |
| | | | BSSID: 0006255D537E |
| | | | beacon interval: 100 |
| | | | capabilities: 0x1 |
| | | | SSID: SecondAccessPoint |
| | | | rate: 5120 (Kb/s) |
| wl-radio-status | | L1 | Report the status of the |
| | | | radio of module 120 |
| wl-associate | string 1 [string2] [string3] | L1 | Associate module 120 with |
| | | | specified Access Point |
| | | | string1 - Access Point SSID |
| | | | string2 - logon ID |
| | | | string3 - logon Password |
| wl-auto-assoc | integer | L1 | When set to 1, when module |
| | | | 120 powers up, it automatically |
| | | | associates with Access Point |
| | | | matching the SSID parameter. |
| | | | 0 - disable auto association |
| | | | 1 - enable auto association |

TABLE 9C
Remote Device/Host Communication Commands

| Command | CLI Arguments | Ln | Description |
|---|---|---|---|
| wl-retry-time | [integer] | L2 | Interval in seconds between connection retries. 32 bits |
| | | | unsigned. Default = 60. |
| wl-tcp-timeout | [integer] | L2 | TCP session inactivity timeout (seconds). Use 0 to disable |
| | | | this feature. 32 bits unsigned. Default = 60. |
| wl-telnet-timeout | [integer] | L2 | Module 120 Telnet server session inactivity timeout |
| | | | (seconds). Use 0 to disable this feature. 32 bits unsigned. |
| | | | Default =60. |
| wl-telnet-port | [integer] | L2 | Module 120 Telnet server port number. 32 bits unsigned. |
| | | | Default = 23 decimal. |
| wl-http-port | [integer] | L2 | Module 120 web server port number used to listen on. |
| | | | 32 bits unsigned. Default = 80 decimal. |
| wl-tcp-port | [serialport] [integer] | L2 | TCP port number to use when host 110 initiates TCP |
| | | | connection with a remote server. 32 bits unsigned. |
| wl-tcp-ip | [serialport] [integer] | L2 | TCP IP address to use when host 110 initiates TCP |
| | | | connection with a remote server. 32 bit unsigned. |
| | | | Default = 0x00000000. |
| wl-auto | [serialport] [integer] | L2 | When set to 1, module 120 powers up and initiates a TCP |
| | | | connection with remote server and enters pass-through |
| | | | mode - will reconnect if disconnected. Applies connection |
| | | | to specified serial port. |
| | | | 0 = disable (default) |
| | | | 1 = enable feature |
| mode | [integer] | L1 | Mode - 32-bit bitmap - not persistent across boot-up |
| | | | 0 = normal pass-through (default) |
| | | | 1 = echo pass-through data back to initiator |
| pass | [serialport] | L1 | Enter pass-through mode and make a connection if one is |
| | | | not already open. Module 120 will respond with OK or |
| | | | ERROR depending upon whether connection can be made. |
| | | | If error, serial interface remains in CLI mode. |
| [symbol] ds | | L1 | Escape sequence switches serial interface to CLI mode. |
| | | | Default = 0x7E7E7E6473 which is “ [symbol] ds” |
| escape | integer | L1 | Sets the escape sequence to the specified value. |
| | | | 5 bytes max. Default = 0x7E7E7E6473, is “ [symbol] ds” |
| putget | serialport #bytes timeout | L1 | Module 120 connects (if required) to IP address and port |
| | senddata | | number. Module 120 transfers senddata to remote IP |
| | | | application and waits for #bytes or timeout. Excess bytes |
| | | | are discarded. After command completes, serial interface |
| | | | remains in CLI mode. |
| | | | #bytes - integer - 0-1800 bytes max |
| | | | timeout - integer - 32 bit unsigned, seconds |
| | | | senddata - binary - 1500max length of command line |
| putexpect | serialport terminator | L1 | Module 120 connects (if required) to IP address and port |
| | max#bytes timeout | | number. Module 120 transfers senddata to remote IP |
| | senddata | | application and waits for max#bytes or timeout or |
| | | | terminator. Excess bytes are discarded. After command |
| | | | completes connection, serial interface remains in CL1 mode. |
| | | | terminator - binary - 16 bytes max |
| | | | max#bytes - integer - 0-1800 bytes max |
| | | | timeout - integer - 32 bit unsigned seconds |
| | | | senddata - binary - max length of command line |
| close | | L1 | Closes a TCP connection initiated by host 110. Command |
| | | | may be sent from any CLI communication interface. |
| | | | Connections initiated by Telnet and HTTP must be managed |
| | | | by those applications. |
| listen | | L2 | Sets serial interface to listen mode, allowing module 120 to |
| | | | accept connections or exchanges from other CLI |
| | | | communication interfaces. Command may only be issued by |
| | | | host 110. |
| | | | If a connection is already open an error will be returned. |

TABLE 9D
Serial Interface Configuration Commands

| Command | CLI Arguments | Ln | Description |
|---|---|---|---|
| bit-rate | [serialport][integer] | L2 | Serial interface bit-rate: |
| | | | Default = 9600. |
| | | | Valid rates are: 300\|600\|1200\| |
| | | | 2400\|4800\|9600\|14400\|19200\| |
| | | | 28800\|38400\|57600\|115200\| |
| | | | 230400\|460800\|921600 |
| data-bits | [serialport][integer] | L2 | Data bits for serial interface: |
| | | | 7 or 8. Default = 8 |
| parity | [serialport][string] | L2 | Parity for serial interface: |
| | | | n = none (default) |
| | | | e = even |
| | | | o = odd |
| flow | [serialport][string] | L2 | Flow control for serial interface: |
| | | | n = none, default |
| | | | h = hardware (RTS, CTS) |
| | | | s = software (DC1, DC3) |

TABLE 9E
Discovery Service (UDP based) Commands

| | CLI | | |
|---|---|---|---|
| Command | Arguments | Ln | Description |
| name-manuf | [string] | L4 | Discovery name: manufacturer [31 |
| | | | chars max]. |
| | | | Default = “DPAC-Airborne-A”. |
| name-oem | [string] | L3 | Discovery name: OEM [31 chars |
| | | | max]. Default = “OEM-Cfg1”. |
| name-device | [string] | L2 | Discovery name: device [31 |
| | | | chars max]. |
| | | | Default = “Device”. |

TABLE 9F
Administration Commands

| Command | CLI Arguments | Ln | Description |
|---|---|---|---|
| help\|? | | L1 | Display the commands available |
| | | | at the current security level. |
| ver-fw | | L1 | Firmware version string [31 |
| | | | chars max]. |
| ver | [string] | L3 | OEM version string [31 chars |
| | | | max]. If no argument is |
| | | | given, the current oemverstr |
| | | | will be returned for any security |
| | | | level. |
| | | | Default = “oemverstr”. |
| user-manuf | [string] | L4 | Level 4 user ID [31 chars |
| | | | max]. Default = “dpac”. |
| user-oem | [string] | L3 | Level 3 user ID [31 chars |
| | | | max]. Default = “oem”. |
| user-cfg | [string] | L2 | Level 2 user ID [31 chars |
| | | | max]. Default = “cfg”. |
| user | [string] | L1 | Level 1 user ID [31 chars |
| | | | max]. Default = “user”. |
| pw-manuf | string | L4 | Level 4 Password [31 chars |
| | | | max]. Default = “dpac”. |
| pw-oem | string | L3 | Level 3 Password [31 chars |
| | | | max]. Default = “oem”. |
| pw-cfg | string | L2 | Level 2 Password [31 chars |
| | | | max]. Default = “cfg”. |
| pw | string | L1 | Level 1 Password [31 chars |
| | | | max]. Default = “password”. |
| auth | [string1 | L1 | Login in to module 120 - |
| | string2] | | persistent until logout or |
| | | | restart - not persistent |
| | | | across restart. |
| | | | string1 - user ID |
| | | | string2 - password |
| | | | If no arguments are given, a |
| | | | natural number will be returned |
| | | | indicating the current security |
| | | | level. |
| logout | | L1 | Return to Level 1. |
| restart | | L1 | Restart the firmware. |
| update | [string] | L3 | Updates the module 120 firmware |
| | | | with the specified file name. |
| | | | [31 chars max]. If no file |
| | | | name is specified, prompts the |
| | | | user for SREC format file. |
| | | | NOTE that all other activity |
| | | | in the module 120 is shut down |
| | | | during this process. |
| commit | | L2 | Commit the module 120 |
| | | | configuration to flash. |
| time | [integer] | L1 | Set/Get the current time_t, as |
| | | | returned by time( ) POSIX |
| | | | function, representing the |
| | | | number of seconds since 00:00:00 |
| | | | January 1, 1970 (non-persistent), |
| | | | module 120 time starts ticking |
| | | | at startup from 0. |
| reset | | L3 | Reset all settings to OEM defaults. |

TABLE 9G
Digital I/O Commands

| Command | CLI Arguments | Ln | Description |
|---|---|---|---|
| io-read | <portid> | L1 | Read digital I/O port |
| io-write | <portid> <integer1> | L1 | Write digital value to |
| | | | digital I/O port |
| | | | integer1 - value, 0 or 1 |
| io-dir | <portid> <in \| out> | L1 | Sets the direction of the |
| | | | digital I/O port to Input |
| | | | or Output |

TABLE 9H
Analog Inputs Commands

| Command | CLI Arguments | Ln | Description |
|---|---|---|---|
| adc-read | <portid> | L1 | Read Analog input port |
| | | | Range of returned value is: |
| | | | 0x0000 (0) to 0x03FF (1023) in |
| | | | integer steps. |

In the commands of Tables 9A-H above, the following conventions can be applied:
All commands consist of a string of printable characters including the command and optional arguments delimited by one or more spaces or tabs. Multiple consecutive spaces or tabs are considered as one delimiter.
Commands and arguments are case sensitive.
Arguments enclosed with [. . . ] are optional.
All arguments are literal ASCII text except where indicated.
Most commands that set the value of a parameter can also obtain the value of the parameter by omitting the argument. Numeric values will be returned in aschex format.
A choice between arguments is indicated with the | character—only one of the choices may be selected.
The maximum length of a CLI command line is limited to available module resources. In one embodiment, the maximum length can be 1800 characters including spaces and terminating characters.
All CLI commands must be terminated with a <CRLF> pair.
Argument types include:
   <string>-literal ASCII string without delimiters (no spaces or tabs)
   <integer>-value represented as “aschex” or decimal integer. Aschex values are entered in form: 0xhhh . . . hhh
   <binary>-string represented by a string of hexadecimal digits (no prefix required)
   <portid>-two character ID, such as F0, G3, etc, that specifies a reference to one of the GPIO digital or analog ports on application processor 220
   <serialport>-single numeric digit that identifies which of the eight serial ports (a subset of ports 230) through which a serial interface connection will communicate. Valid port numbers are 1-9. When host 110 issues commands that require this argument, it should specify 0. Telnet and HTTP connections must specify a non-zero port number. In one embodiment, only port 1, the high-speed serial is supported.

As illustrated in FIG. 4, module 120 can implement a CLI server that accepts and processes CLI commands received over the serial interface to host 110, and/or commands received over wireless link 135 by the web server and/or Telnet server of module 120. Thus, in such an embodiment, CLI commands can be utilized over CLI communication interfaces (a), (b), and (c) previously described herein. The CLI server of module 120 can be implemented such that module 120 responds to CLI commands on the CLI communication interface over which the command was received.

The serial interface connection between host 110 and module 120 can be realized by serial ports of physical ports 230. Data passed over the serial interface can be implemented in accordance with a host-oriented protocol or other appropriate protocol, as previously described herein.

In various embodiments, the serial interface connection of module 120 can operate in a plurality of modes. In one embodiment, three such modes are supported: (1) CLI mode; (2) listen mode; and (3) pass-through mode. In CLI mode, the serial interface will respond to CLI commands from host 110, while commands received from any other CLI communication interfaces (i.e. interfaces (b) and (c) described above) are ignored. In listen mode, the serial interface will respond to CLI commands received from any of the CLI communication interfaces (a), (b), or (c) described above. In pass-through mode, raw data can be tunneled back and forth over the serial interface, permitting the raw data to be passed between host 110 and remote device 170. To ensure that host 110 and module 120 are synchronized regarding the characterization of data on the serial interface, the operation of these various modes is subject to the various arbitration rules further set forth herein.

In one embodiment, only one communication session at a time can send and receive data over the serial interface connection between module 120 and host 110. These sessions include: (1) host-initiated communication using the serial interface in CLI or pass-through mode; (2) putget or putexpect commands received through the web server of module 120; (3) a Telnet session through the Telnet server of module 120 using putget, putexpect, and pass-through mode; and (4) a TCP connection initiated by host 110 or remote device 170.

Module 120 can be implemented such that host 110 has priority over the serial interface. If the host 110 decides it wants the serial interface and issues an escape sequence CLI command to module 120, the serial interface is placed into CLI mode, and host 110 is given ownership of the serial interface. Any other session activity on the serial interface is immediately terminated. The escape string is nevertheless transmitted through the connection before the connection is terminated.

The following Table 10 sets forth an example, illustrating a sample sequence of commands and interaction between host 110 and module 120 using the serial interface.

TABLE 10

| Action by Module | Direc- | | |
|---|---|---|---|
| 120 | tion | Action by Host 110 | Comments |
| | [symbol] | [symbol] ds<CRLF> | Host 110 issues an escape sequence CLI |
| | | | command to set the serial interface to CLI |
| | | | mode, and to reserve ownership of the serial |
| | | | interface. |
| | | | This command may be issued to module |
| | | | 120 at ANY time. Any active session over |
| | | | the serial interface is terminated. |
| OK<CRLF> | → | | Module 120 responds and indicates that the |
| | | | request for ownership of the serial interface |
| | | | was successful. All further communication |
| | | | over the serial interface will follow the |
| | | | defined CLI commands and responses. |
| | [symbol] | wl-tcp-ip | Host 110 sends a CLI command to set the IP |
| | | 0xc0232323<CRLF> | address of the remote device 170 the host |
| | | | 110 will want to connect with. |
| OK<CRLF> | → | | Module 120 responds and indicates that |
| | | | command was successfully executed. |
| | [symbol] | wl-tcp-timeout 30<CRLF> | Host 110 continues issuing CLI commands. |
| OK<CRLF> | → | | Module 120 responds to each CLI command. |
| | [symbol] | pass 0<CRLF> | Host 110 wishes the serial interface to |
| | | | switch to pass-through mode and make a |
| | | | connection to the previously defined remote |
| | | | device 170 - data passed between host 110 |
| | | | and the remote device 170 will be |
| | | | transparently tunneled. |
| | [symbol] | 01010101001010 | Host 110 sends raw binary data |
| [symbol] module 120 forwards | | | Opens connection to target TCP-port if not |
| data stream to remote | | | already open |
| device 170 | | | |
| → module 120 receives | → | 01010101001010 | Module 120 forwards received raw binary |
| data from remote device | | | data from remote device 170 to host 110 |
| 170 | | | |
| | [symbol] | [symbol] ds<CRLF> | Host 110 requests to escape from pass- |
| | | | through mode and return to CLI mode. |
| | | | Serial interface will return to CLI mode, but |
| | | | will NOT end the TCP connection. |
| OK<CRLF> | → | | Module 120 indicates that escape sequence |
| | | | command was successful. Further |
| | | | communication over the serial interface |
| | | | must adhere to the defined CLI command format. |
| | [symbol] | close<CRLF> | Host 110 requests module 120 to close the |
| | | | TCP connection with the remote device 170. |
| OK<CRLF> | → | | Module 120 responds to CLI command. |
| | [symbol] | listen<CRLF> | Host 110 releases control of the serial |
| | | | interface - this allows other CLI |
| | | | communication interfaces to initiate |
| | | | connection to the host 110 via the serial |
| | | | interface through which host 110 issued the |
| | | | command. |

When in listen mode, module 120 does not provide delineation of requests or indication of a request's source. The request data must be designed to provide adequate identification so that the host 110 can respond with the correct information. For example, the data in a putget or putexpect command issued by Java Script embedded in resident HTML should include enough information so that after the data is forwarded, host 110 can discern the source of the data and respond accordingly. Similarly, the data in a putget or putexpect command issued by host 110 to remote device 170, as well as the response data from the remote device 170, should include sufficient information for each to discern the communication source in order to send corresponding response data.

Regarding the escape sequence command: there is no escape sequence command transparency (i.e. there is no need to prefix escape characters with an escape prefix); the escape sequence is a fixed length 5 byte sequence; the CLI commands have no way of clearing the escape value; only one escape is defined for all CLI communication interfaces.

Module 120 does not allow remote device 170 to permanently own control of the serial interface. However, when the host 110 releases ownership of the serial interface with a listen CLI command, remote device 170 can issue a pass through command, causing the serial interface to enter pass through mode, allowing module 120 to tunnel data from remote device 170 to host 110. At any time though, the host 110 may regain ownership of the serial interface, and block the remote device 170 client from tunneling data. It will be appreciated that such functionality is useful for configurations where the host 110 needs to urgently communicate information. Remote device 170 clients, such as a remote device 170 acting as a Telnet or HTTP client, may issue a pass command to tunnel data to the host 110. However, if the host 110 has ownership of the serial interface (either by: (1) the serial interface being in CLI mode; or (2) the serial interface being in a pass-through mode initiated by host 110), module 120 will reject such a request.

When module 120 powers up, various parameters can affect whether module 120 attempts to make a connection with a remote device 170. In one embodiment, the wl-auto state can determine such operation. If it is disabled, the serial interface will be set to CLI mode upon power up. When it is enabled, module 120 will attempt to connect to the wl-tcp-ip address of remote device 170. If the connection is successful, the serial interface is set to pass-through mode, as if host 110 issued a pass CLI command. If the connection fails, module 120 will send an escape sequence CLI command to host 110, and continue to retry the connection.

In one embodiment, the serial interface can be implemented to default to a host-initiated pass-through mode (acting as if the pass-through mode were initiated by host 110; i.e. module 120 attempts to make a TCP connection to the last defined wl-tcp-ip address and sets the serial interface in pass-through mode), on start up.

When the serial interface is set to pass-through mode by the host 110, the following are true:
The pass-through CLI command will cause module 120 to open a TCP connection to the remote device 170 if one is not already open.
A remote device 170 should be designed to be listening on the target TCP port.
Once the connection is made, module 120 will provide an OK response to the host 110. If after several attempts the connection cannot be opened module 120 will provide an ERROR response.
The remote device 170 IP address and its TCP port are specified by the wl-tcp-ip and wl-tcp-port CLI commands.
All data received on the serial interface from the host 1 10 is tunneled to the remote device 170 as TCP payload.
All data received from the remote device 170 is tunneled to the host 110 on the serial interface.
The host 110 can return the serial interface to CLI mode by issuing the escape sequence CLI command. This does not terminate the TCP connection. The escape sequence is transmitted to the remote device 170.
Module 120 buffers sufficient data to ensure proper detection of the escape sequence CLI command.
The remote device 170 can only end this session by closing the TCP port from the remote device 170 side.
The host 110 can end the TCP session by returning the serial interface to CLI mode and issuing a close command.
If the TCP connection ends for any reason outside the control of the host 110, module 120 will send an escape sequence CLI command to the host 110 and return the serial interface to CLI mode.
The host 110 should always look for the escape sequence.

When module 120 detects and executes an escape sequence CLI command received from the host 110, the following are true:
The escape sequence is transmitted to the remote device 170.
Module 120 sends an OK response to the host 110.
The host 110 becomes the owner of the serial interface.
Module 120 will process data received from the host 110 as CLI commands.
The TCP connection established by the prior pass-through mode does not necessarily close unless a timeout occurs, the link is lost, or module 120 receives a close CLI command on any CLI communication interface.
The senddata content of the CLI putget or putexpect commands are passed from the host 110 to the destination remote server.

When module 120 detects and executes the “listen” command received from the host 110, the following are true:
The serial interface will revert to a “listen” mode which allows putget, putexpect, or pass-through commands to be sent to module 120 through Telnet, TCP, or HTTP.
The senddata content of these commands will be passed on to the host 110.
The host 110 temporarily relinquishes ownership of the serial interface providing other CLI communication interfaces access to it.
The serial interface can be switched to a pass-through mode, initiated by remote device 170.
The host 110 can at any time regain control of the serial interface and switch the serial interface to CLI mode by issuing the escape sequence. The escape sequence is transmitted to the CLI communication interface that is in pass-through mode and has control of the serial interface.

In various embodiments, when pass-through mode has been initiated by host 110, the TCP connection is kept open until host 110 closes the connection or module 120 receives a close CLI command over any CLI communication interface. No other CLI communication interface can initiate pass-through mode or have module 120 execute putget or putexpect CLI commands while the host 110 initiated pass-through TCP connection is open or the serial interface is in CLI mode.

In various embodiments, putget or putexpect commands issued by host 110 cause module 120 to open a TCP connection to a remote device 170, send data, get data, transfer the data to the host 110, and close the TCP connection. The whole transaction is intended to be short and quick so that the serial interface can rapidly switch between CLI mode and listen mode. This latter capability is important if the host 110 wishes to be able to receive ad hoc putget data over the web server of module 120.

As previously described herein, module 120 provides a Telnet server. Once a Telnet session is established from remote device 170, the Telnet server expects that any further data it receives from remote device 170 will be in the form of a CLI command. Remote device 170 can then send CLI commands to the CLI server of module 120.

After a Telnet connection is established, the following applies:
Module 120 starts each Telnet session expecting CLI commands.
The remote device 170 acting as a Telnet client may issue CLI commands to module 120 over this session no matter what mode or state the host 110 is in. The Telnet client should expect responses to commands as defined in the CLI commands.
If putget or putexpect commands are issued, the senddata content of the commands will be passed to the host 110.
The Telnet client may issue a “pass” command to enter pass-through mode with the host 110. This command is successful only if the serial interface is in “listen” mode.
When the serial interface is in pass-through mode, module 120 will tunnel data between the host 110 and the Telnet client until either side issues the escape sequence CLI command.
No matter who issues the escape sequence CLI command, the command is also transmitted to the other side of the connection.
If the Telnet client issued the escape sequence CLI command, the Telnet server of module 120 will revert to expecting CLI commands. The serial interface will remain in “listen” mode.
If the host 110 issued the escape sequence CLI command, the Telnet server of module 120 will continue to expect pass through data, while the serial interface enters CLI mode. While the serial interface is in CLI mode, any data sent by the Telnet client will be blocked.

The following Table 11 sets forth an example of a Telnet session where commands are sent and data is exchanged.

TABLE 11

| Action by | | | | | |
|---|---|---|---|---|---|
| Remote Device 170 | Direc- | Action by | Direc- | Action by | |
| (Telnet client) | tion | Module 120 | tion | Host 110 | Comments |
| telnet <module 120 IP | → | | | | Telnet client connects to module 120 |
| adrs> | | | | | Telnet server |
| | [symbol] | Telnet server | | | Connection accepted by module 120. |
| | | accepts | | | Telnet server expects to receive |
| | | connection | | | CLI commands. |
| bit-rate 1 9600<CRLF> | → | | | | Telnet client issues the bit-rate command |
| | [symbol] | OK<CRLF> | | | Module 120 services the command and responds. |
| pass 1<CRLF> | → | | | | Telnet client requests that the serial interface |
| | | | | | switch to pass-through mode. Module 120 |
| | | | | | checks that it is in “listen” mode |
| | [symbol] | OK<CRLF> | | | Module 120 indicates it is OK to transmit |
| | | | | | pass-thru data |
| 01010101001 | → | | | | Telnet client sends raw data |
| | | 01010101001 | → | | Module 120 forwards raw data |
| | | | → | 11101010101 | Host 110 receives raw data |
| | | | [symbol] | 11101010101 | Host 110 may send raw data |
| | [symbol] | 11101010101 | | | Module 120 forwards raw data to the Telnet |
| | | | | | client |
| 11101010101 | [symbol] | | | | The Telnet client receives the raw data |
| | | | | | from module 120 |
| [symbol] ds<CRLF> | → | [symbol] ds<CRLF> | → | [symbol] ds<CRLF> | Telnet client commands |
| | | | | | module 120 to set the serial interface back to |
| | | | | | CLI mode - escape sequence is passed to |
| | | | | | host 110 |
| | [symbol] | OK<CRLF> | | | Module 120 sets serial interface to CLI mode, |
| | | | | | OKs the Telnet client |

Regarding the browser-based data communication previously described above, the process of FIG. 6 can be performed in conjunction with appropriate CLI commands set forth herein. In various embodiments, the following must be true during such a process:
The serial interface must be in “listen” mode to be able to receive and respond to putget, putexpect, or pass-through data.
Module 120 will execute CLI “putget” or “putexpect” commands issued by remote device 170 and pass the senddata content to the host 110.
Data sent to the host 110 requesting content must include sufficient identification of the source and context of the requesting data to allow the host 110 to provide corresponding appropriate return data.
When using the putget/putexpect commands, the host 110 may respond with complete HTML blocked data, which can be embedded in the web page by the Java Script.
It is recommended that only putget or putexpect CLI commands be used from embedded Java Script.

It will be appreciated that the scope of the present invention is not limited by the particular embodiments set forth herein. It is contemplated that the ordering of steps explained herein can be changed where appropriate, and that various steps can be combined into composite steps and/or dissected into substeps where appropriate. In addition, it is contemplated that, in addition to and/or as an alternative to the data formats previously described herein, data transmitted and/or received pursuant to various embodiments of the present invention can be formatted in accordance with an appropriate string format, binary data format, an ASCII Hex format, and/or other appropriate formats. Other appropriate variations of the present invention, whether explicitly provided for or implied, are also contemplated by the present disclosure.

1. A module adapted to be embedded in a host device for providing wireless functionality to said host device, said module comprising:
a wireless radio supporting a wireless protocol;
an antenna in communication with said radio, said antenna capable of transmitting and receiving wireless signals over a wireless link;
an application processor in communication with said radio;
a plurality of physical ports in communication with said application processor, said ports supporting a host-oriented protocol; and
software running on said processor, said software facilitating data exchange between said ports and said radio by converting said data between said host-oriented protocol of said ports and said wireless protocol of said radio, thereby providing said host device with network connectivity.

2. The module of claim 1, wherein said radio comprises:
a baseband processor; and
a MAC interface.

3. The module of claim 1, further comprising:
memory for storing a configuration of said module.

4. The module of claim 3, wherein said configuration can be updated by said host device in communication with said module via said ports.

5. The module of claim 3, wherein said configuration can be updated remotely.

6. The module of claim 5, wherein said remote updating is initiated by software running on a remote device in communication with said module via said wireless radio.

7. The module of claim 1, wherein said wireless protocol is selected from the group consisting of:
a protocol complying with a IEEE 802.11 wireless standard;
a protocol complying with a Bluetooth® wireless technology;
a protocol complying with a ZigBee™ wireless technology; and
a protocol complying with an UWB (ultra wide band) wireless technology.

8. A method for exchanging data between a remote device and a host device over a wireless link, comprising:
receiving an HTML page request from said remote device over said wireless link;
returning an HTML page to said remote device over said wireless link in response to said page request, said HTML page comprising code for issuing data request commands, said code executable by said remote device;
receiving a data request command from said remote device over said wireless link;
passing at least a portion of said data request command to said host device;
receiving requested data from said host device; and
passing said requested data to said remote device over said wireless link.

9. The method of claim 8, wherein said method is performed by a module in communication with said remote device and said host device.

10. The method of claim 9, wherein said module is embedded in said host device for providing wireless functionality to said host device.

11. The method of claim 10, wherein said host device is an OEM product.

12. The method of claim 8, wherein said data request command is received in response to said remote device executing said code.

13. The method of claim 12, wherein said code is JavaScript code.

14. The method of claim 8, wherein said commands comprise a subset of a command set recognized by said module.

15. A method for exchanging data between a remote device and a host device over a wireless link, said method performed by a module adapted to be embedded in said host device for providing wireless functionality to said host device, said method comprising:
receiving a pass-through command from a remote device;
entering a pass-through mode in response to said pass-through command;
passing data received from said remote device to said host device during said pass-through mode;
passing data received from said host device to said remote device during said pass-through mode;
receiving a command to escape said pass-through mode; and
escaping said pass-through mode in response to said command to escape said pass-through mode.

16. The method of claim 15, wherein said pass-through command is received through a Telnet server of said module.

17. The method of claim 15, wherein said pass-through command is received through a web server of said module.

18. The method of claim 15, wherein said commands comprise a subset of a command set recognized by said module.

19. A method for exchanging data between a remote device and a host device over a wireless link, comprising:
receiving a command from said host device to communicate with said remote device;
opening a port to said remote device in response to said command;
transmitting data to said remote device;
receiving data from said remote device in response to said transmitting step;
returning said received data to said host device; and
closing said port.

20. The method of claim 19, wherein said method is performed by a module providing wireless functionality to said host device, said module in wireless communication with said remote device over said wireless link.

21. The method of claim 19, wherein each of said transmitted data and said received data is formatted in accordance with a format selected from the group consisting of:
a string format;
a binary data format; and
an ASCII Hex format.

22. The method of claim 19, wherein said command comprises a subset of a command set recognized by said module.

23. A method for exchanging data between a remote device and a host device over a wireless link, said method performed by a module adapted to be embedded in said host device for providing wireless functionality to said host device, said method comprising:
receiving a command from said host device to communicate with said remote device; and
executing said command, wherein said execution causes said module to perform the steps of:
opening a port to said remote device over a wireless link,
transmitting data included in said command to said remote device over said wireless link,
receiving data from said remote device over said wireless link,
transmitting said received data to said host device, and
closing said port.

24. The method of claim 23, wherein each of said transmitted data and said received data is formatted in accordance with a format selected from the group consisting of:
a string format;
a binary data format; and
an ASCII Hex format.

25. The method of claim 23, wherein said command comprises a subset of a command set recognized by said module.

26. A method for exchanging data between a remote device and a host device over a wireless link, comprising:
receiving a command from said remote device to communicate with said host device;
opening a port to said host device in response to said command;
transmitting data to said host device;
receiving data from said host device in response to said transmitting step;
returning said received data to said remote device; and
closing said port.

27. The method of claim 26, wherein said method is performed by a module providing wireless functionality to said host device, said module in wireless communication with said remote device over said wireless link.

28. The method of claim 26, wherein each of said transmitted data and said received data is formatted in accordance with a format selected from the group consisting of:
a string format;
a binary data format; and
an ASCII Hex format.

29. The method of claim 26, wherein said command comprises a subset of a command set recognized by said module.

30. A method for exchanging data between a remote device and a host device over a wireless link, said method performed by a module adapted to be embedded in said host device for providing wireless functionality to said host device, said method comprising:
receiving a command from said remote device over a wireless link to communicate with said host device; and
executing said command, wherein said execution causes said module to perform the steps of:
opening a port to said host device,
transmitting data included in said command to said host device,
receiving data from said host device,
transmitting said received data to said remote device over said wireless link, and
closing said port.

31. The method of claim 30, wherein each of said transmitted data and said received data is formatted in accordance with a format selected from the group consisting of:
a string format;
a binary data format; and
an ASCII Hex format.

32. The method of claim 30, wherein said command comprises a subset of a command set recognized by said module.

33. A method for remotely configuring a module over a wireless link, said method performed by a configuration utility running on a remote device in communication with said module over said wireless link, said method comprising:
modifying a configuration of said module, wherein said configuration comprises a plurality of configuration parameters;
modifying HTML pages to be served by said module;
modifying code embedded in said HTML pages; and
uploading said modified configuration, said modified HTML pages, and said modified code to said module.

34. The method of claim 33, wherein said module is adapted to be embedded in a host device for providing wireless functionality to said host device.

35. The method of claim 33, wherein said HTML pages comprise a graphical user interface for displaying data on a browser of said remote device, wherein said data is received by said module from a host device.

36. The method of claim 33, further comprising:
downloading said configuration from said module prior to said first modifying step.

37. The method of claim 33, wherein said configuration is an OEM configuration.

38. A method for implementing authentication security, said method performed by a module adapted to be embedded in a host device for providing wireless functionality to said host device, said method comprising:
receiving an authentication command;
determining an access level in response to said authentication command;
receiving a second command to be executed by said module;
comparing said access level to a security level associated with said second command; and
executing said second command if said access level is sufficient to satisfy said security level.

39. The method of claim 38, wherein said commands are issued to said module by said host device.

40. The method of claim 38, wherein said commands are issued to said module by said remote device.

41. The method of claim 38, wherein said authentication command comprises:
a user ID; and
a password.

42. The method of claim 38, wherein said commands comprise a subset of a command set recognized by said module.

43. A command set for a module adapted to be embedded in a host device for providing wireless functionality to said host device, said command set supporting commands capable of instructing said module to perform at least a portion of a method selected from the group consisting of:
a method for exchanging data between a remote device and said host device over a wireless link;
a method for remotely configuring said module over said wireless link; and
a method for implementing authentication security.

44. The command set of claim 43, wherein said commands are CLI commands.
